(19) United States
(12) Patent Application Publication
(10) Pub. No.: US 2022/0283044 A1
(43) Pub. Date: Sep. 8, 2022

(54) STRESS-STRAIN CURVE SIMULATION METHOD

(71) Applicants: Inventec (Pudong) Technology Corporation, Shanghai (CN); INVENTEC CORPORATION, Taipei (TW)

(72) Inventors: De bin QI, Shanghai (CN); Xuefeng CHEN, Shanghai (CN); Yu TANG, Shanghai (CN); Qingxuan XU, Shanghai (CN); Xiang bin CHEN, Shanghai (CN); Xiaowei ZHANG, Shanghai (CN)

(21) Appl. No.: 17/346,629

(22) Filed: Jun. 14, 2021

(30) Foreign Application Priority Data
Mar. 2, 2021 (CN) 202110231299.1

(51) Int. Cl. G01L 1/00; G01L 5/00

(52) U.S. Cl. CPC G01L 1/005; G01L 5/0052

(57) ABSTRACT

A stress-strain curve simulation method, for calculating a simulated stress-strain curve of a test object sandwiched between a mass block and a testing platform, the method comprises: obtaining a first acceleration curve associated with a plurality of pieces of acceleration data of the mass block and a second acceleration curve associated with a plurality of pieces of acceleration data of the testing platform; extracting a part of the first acceleration curve and a part of the second acceleration curve to obtain a first valid curve and a second valid curve; obtaining an object strain curve according to the first valid curve and the second valid curve; calculating an object stress curve based on the first valid curve and a contact area between the mass block and the test object; and calculating the simulated stress-strain curve based on the object strain curve and the object stress curve.

### CROSS-REFERENCE TO RELATED APPLICATIONS

This non-provisional application claims previously under 35 U.S.C. § 119(a) on Patent Application No(s). 202110231299.1, filed in China on Mar. 2, 2021, the entire contents of which are hereby incorporated by reference.

### BACKGROUND

### 1. Technical Field

This disclosure relates to a stress-strain curve simulation method.

### 2. Related Art

When performing drop test by computer aided engineering (CAE), the complete stress-strain curve of the material being tested (for example, the expanded polyethylene (EPE)) needs to be input to the CAE simulation software. That is, the complete stress-strain curve is, in the strain range of [0, 1), the curve showing the stress of the material changes with the change of strain. However, since different the material properties tested by different manufacturers may all be different, and it's almost impossible to obtain data that is with a strain of 1, it is difficult to simulate a result close to the actual situation by CAE.

### SUMMARY

Accordingly, this disclosure provides a stress-strain curve simulation method.

According to one or more embodiment of this disclosure, a stress-strain curve simulation method, for calculating a simulated stress-strain curve of a test object sandwiched between a mass block and a testing platform, the method comprising: obtaining a first acceleration curve and a second acceleration curve, wherein the first acceleration curve is associated with a plurality of pieces of acceleration data of the mass block, and the second acceleration curve is associated with a plurality of pieces of acceleration data of the testing platform; extracting a part of the first acceleration curve within a time period to obtain a first valid curve, and extracting a part of the second acceleration curve within the time period to obtain a second valid curve; obtaining an object strain curve according to the first valid curve and the second valid curve; calculating an object stress curve based on the first valid curve and a contact area between the mass block and the test object; and calculating the simulated stress-strain curve using an exponential equation based on the object strain curve and the object stress curve, wherein the simulated stress-strain curve is used to follow a tested stress-strain curve.

In view of the above description, the stress-strain curve simulation method according to one or more embodiment of the present disclosure, a more accurate simulated stress-strain curve may be calculated based on the acceleration data of the mass block and the testing platform obtained during the drop test. Therefore, in the subsequent computer aided engineering (CAE) simulation, the simulation result may be more accurate. Furthermore, in the conventional stress-strain test, the closer the strain value to 1 is, the more difficult to obtain said strain value. According to one or more embodiment of the stress-strain curve simulation method of the present disclosure, in the strain range of [0, 1), the strain value that is close to 1 may be obtained. Therefore, when performing simulation by using CAE software, a wider range of stress and strain value may be used as the bases for simulation.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a diagram showing the experiment setup for obtaining acceleration data;

FIG. 2 is a flow chart of a stress-strain curve simulation method according to an embodiment of the present disclosure;

FIG. 3 illustrates diagrams of the acceleration curves and the valid curves;

FIG. 4 illustrates a detailed flowchart of step S30 shown in FIG. 2;

FIG. 5 illustrates diagrams of velocity curves and displacement curves;

FIG. 6 illustrates exemplary diagrams of obtaining the strain curve according to the first displacement curve and the second displacement curve; and

FIG. 7 illustrates diagrams of the tested stress-strain curve and the simulated stress-strain curve.

### DETAILED DESCRIPTION

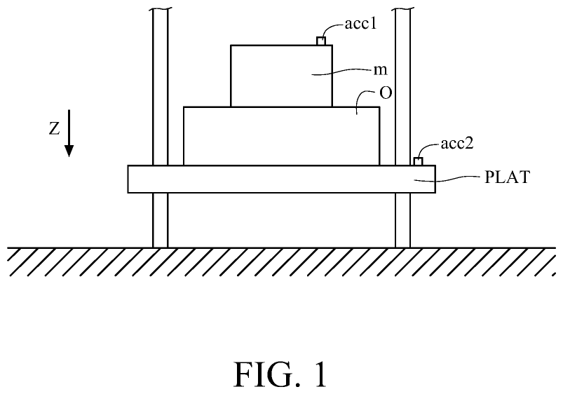

Please refer to FIG. 1, FIG. 1 is a diagram showing the experiment setup for obtaining acceleration data. The stress-strain curve simulation method of the present disclosure is performed based on acceleration data to calculate a simulated stress-strain curve, and the experiment setup shown in FIG. 1 may be configured to obtain the acceleration data adapted for the present disclosure. Specifically, the stress-strain curve simulation method of the present disclosure is configured to calculate the simulated stress-strain curve of a test object 0, wherein the test object O is sandwiched between a mass block m and a testing platform PLAT. An accelerator acc1 is attached to the mass block m, and an accelerator acc2 is attached to the testing platform PLAT, so that the accelerators acc1 and acc2 may obtain the acceleration data associated with the mass block m and the testing platform PLAT when the mass block m, the test object O and the testing platform PLAT are falling to simulate free fall. The acceleration data of the mass block m and the testing platform PLAT may be used to calculate the simulated stress-strain curve. Further, the testing platform PLAT falls along a predetermined path (the free-fall path defined by the two parallel tracks shown in FIG. 1). In this embodiment, the mass of the mass block m is 26.8 KG, the distance between the testing platform PLAT and the ground is 30 inches, so that the maximum velocity of the testing platform PLAT during the fall is approximately the same as the testing platform PLAT touching the ground during an actual free fall. The testing platform PLAT may be lifted up by a buffer external force when descending close to the end of the predetermined path (ground). The test object O is expanded polyethylene (EPE) foam, the thickness of the foam is 50 mm, the density of the foam is 1.7 pcf. The above parameters are merely examples, the present disclosure dose not limit the way of setting up the experiment as well as the parameters.

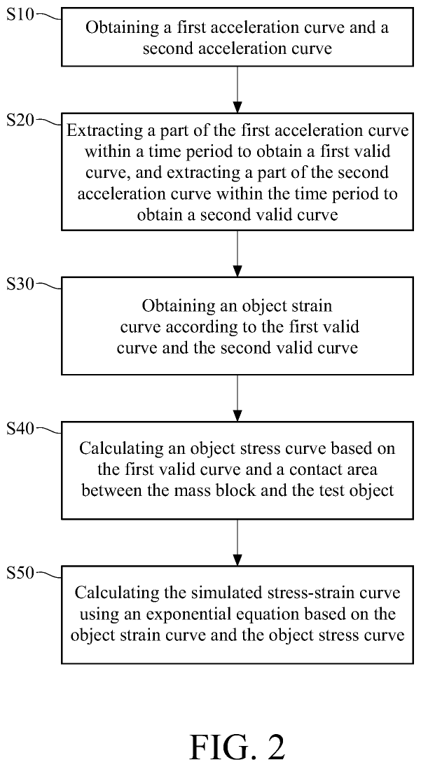

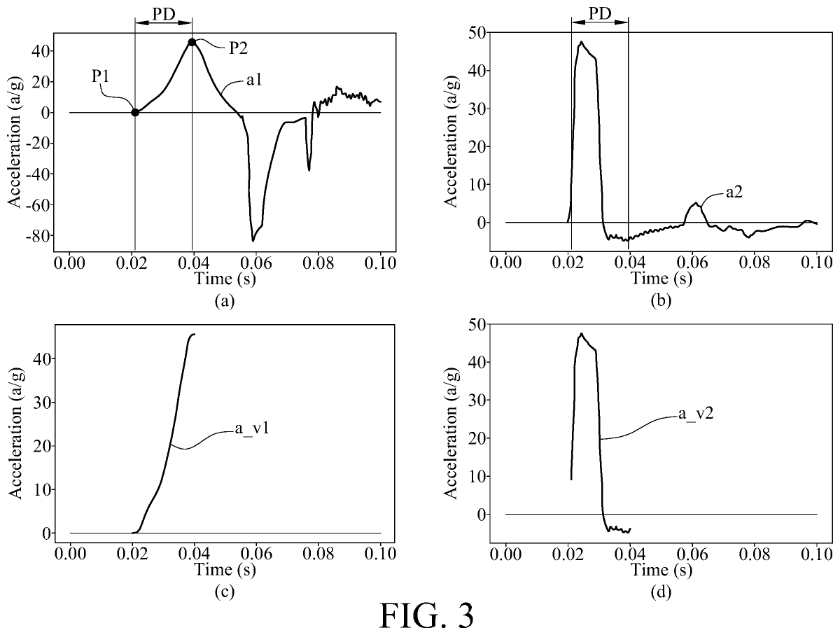

Please refer to both FIG. 2 and FIG. 3, wherein FIG. 2 is a flow chart of a stress-strain curve simulation method according to an embodiment of the present disclosure; FIG. 3 illustrates diagrams of the acceleration curves and the valid curves.

Step S10: obtaining a first acceleration curve and a second acceleration curve.

Part (a) shown in FIG. 3 is the first acceleration curve a1 obtained by the first accelerator acc1. Part (b) shown in FIG. 3 is the second acceleration curve a2 obtained by the second accelerator acc2. The first acceleration curve a1 is associated with a plurality of pieces of acceleration data of the mass block m, the second acceleration curve a2 is associated with a plurality of pieces of acceleration data of the testing platform PLAT, wherein the first acceleration curve a1 and the second acceleration curve a2 are curves of ratios of the actual acceleration values to the gravitational acceleration value versus time (s).

In other words, during the time from the mass block m, the test object O and the testing platform PLAT start to fall until they reach to the ground, the accelerators acc1 and acc2 respectively obtain a plurality of actual acceleration values. The first acceleration curve a1 is a curve generated by respectively dividing the actual acceleration values obtained by the accelerator acc1 at different time point by the gravitational acceleration value; the second acceleration curve a2 is a curve generated by respectively dividing the actual acceleration values obtained by the accelerator acc2 at different time point by the gravitational acceleration value.

Step S20: extracting a part of the first acceleration curve within a time period to obtain a first valid curve, and extracting a part of the second acceleration curve within the time period to obtain a second valid curve.

The acceleration data for calculating the simulated stress-strain curve is preferably the data from the mass block m is about to compress the test object O, to the amount of compression of the test object O reaches the maximum compression. The starting point of this data segment (the first valid data a_v1 shown in part (c) of FIG. 3) corresponds to the first data point P1 where the first acceleration curve a1 of part (a) of FIG. 3 is greater than zero, and the end point of the first valid curve a_v1 is the second data point P2 (peak value) of the first acceleration curve a1. Since the first valid data a_v1 corresponds to a time period PD, the part of the second acceleration a2 of part (b) in FIG. 3 that is extracted based on the same time period PD is the second valid data a_v2.

Step S30: obtaining an object strain curve according to the first valid curve and the second valid curve.

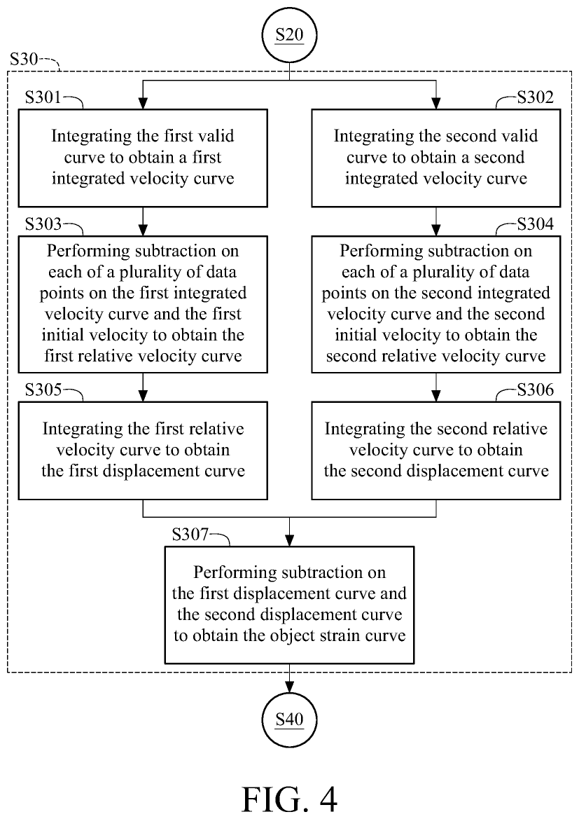

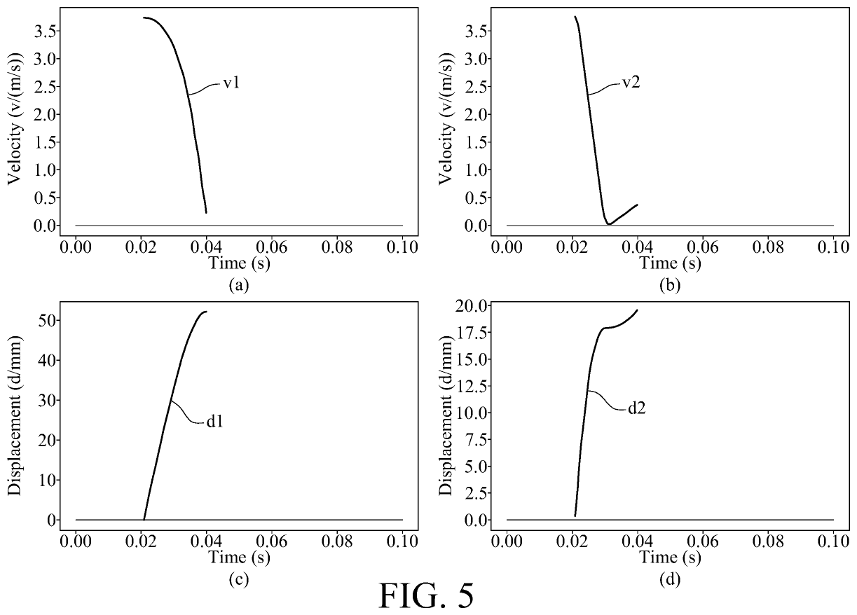

The implementation of step S30 comprises performing an integration procedure respectively on the first valid curve a_v1 and the second valid curve a_v2 to obtain a first displacement curve d1 shown in part (c) of FIG. 5 and a second displacement curve d2 shown in part (d) of FIG. 5. The first displacement curve d1 is then subtracted by the second displacement curve d2 to obtain the object strain curve. For example, the implementation of step S30 comprises performing the integration procedure on both the first valid data a_v1 and the second valid data a_v2 to obtain the first displacement curve d1 and the second displacement curve d2, and the strain curve of the test object O may be first calculated according to the strain equation (ε=d/t) by using the two displacement curves d1 and d2 (a curve of strain versus time will first be obtained), the detail implementation will be further described along with the embodiment of FIG. 4.

Please refer to step S40: calculating an object stress curve based on the first valid curve and a contact area between the mass block and the test object.

Before calculating the strain data, a counter force curve of the test object O exerting on the mass block m is calculated based on the first valid data a_v1 and the mass of the mass block m (F=ma), the object stress curve (now shown) of the test object O is then calculated based on the counter force curve and the contact area between the mass block m and the test object O by using the stress equation (σ=F/S). In this embodiment, since the contact area between the mass block m and the test object O is one surface area of the mass block m as shown in FIG. 1, the area of the surface of the test object O that contacts the mass block m may be used as the contact area.

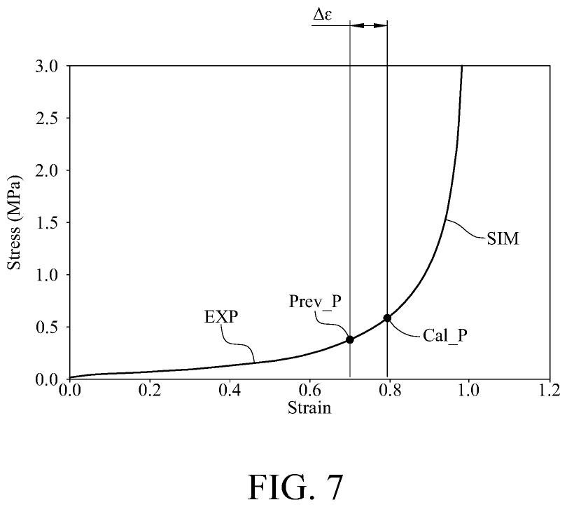

In addition, after obtaining the object strain curve in step S30 and the object stress curve in step S40, the object strain curve and the object stress curve may be combined to obtain the tested stress-strain curve EXP as shown in FIG. 7. It should be noted that, in FIG. 2, step S30 is followed by step S40, however, step S40 may also be performed before step S30 or performed simultaneously with step S30, the present disclosure does not limit the order of steps S30 and S40.

Step S50: calculating the simulated stress-strain curve using an exponential equation based on the object strain curve and the object stress curve, wherein the simulated stress-strain curve is configured to follow the tested stress-strain curve EXP.

The exponential equation is, for example, a third-order exponential equation or a seventh-order exponential equation, and calculating the simulated stress-strain curve comprises: using a final data point on the tested stress-strain curve EXP as a previous data point Prev_P; inputting the previous data point Prev_P into the exponential equation to calculate a next data point Cal_P; and updating the previous data point Prev_P by the next data point Cal_P. Accordingly, the updated previous data point may be inputted into the exponential equation to calculate the another next data point. The detail implementation will be described along with FIG. 7.

To further explain the way of obtaining the strain curve according the two valid curves as described in step S30 of FIG. 2, please refer to FIG. 4, FIG. 4 illustrates a detailed flowchart of step S30 shown in FIG. 2.

Step S301: integrating the first valid curve to obtain a first integrated velocity curve; step S302: integrating the second valid curve to obtain a second integrated velocity curve. Since the two valid curves a_v1 and a_v2 both are data associated with acceleration, integrating the two valid curves av_1 and a_v2 may obtain the first integrated velocity curve and the second integrated velocity curve (not shown).

Step S303: performing subtraction on each of a plurality of data points on the first integrated velocity curve and a first initial velocity of the mass block to obtain a first relative velocity curve; step S304: performing subtraction on each of a plurality of data points on the second integrated velocity curve and a second initial velocity of the testing platform to obtain a first relative velocity curve.

Step S303 is subtracting each of the value of data points on the first integrated velocity curve from the first initial velocity to obtain the first relative velocity curve v1 as part (a) of FIG. 5 shown; and step S304 is subtracting each of the value of data points on the second integrated velocity curve from the second initial velocity to obtain the second relative velocity curve v2 as part (b) of FIG. 5 shown, wherein the first initial velocity of the mass block m is the maximum velocity of the mass block m along the falling direction (z axis), and equals to the second initial velocity of the testing platform PLAT. That is, the first initial velocity and the second initial velocity numerically equal to the maximum value on the second integrated velocity curve.

Step S305: integrating the first relative velocity curve to obtain the first displacement curve; step S306: integrating the second relative velocity curve to obtain the second displacement curve.

Step S305 is integrating the first relative velocity curve v1 to obtain the first displacement curve d1 as part (c) of FIG. 5 shown; and step S306 is integrating the second relative velocity curve v2 to obtain the second displacement curve d2 as part (d) of FIG. 5 shown. Accordingly, the displacement-time curve (d1) of the mass block m as well as the displacement-time curve (d2) of the testing platform PLAT may be obtained.

Step S307: performing subtraction on the first displacement curve and the second displacement curve to obtain the object strain curve.

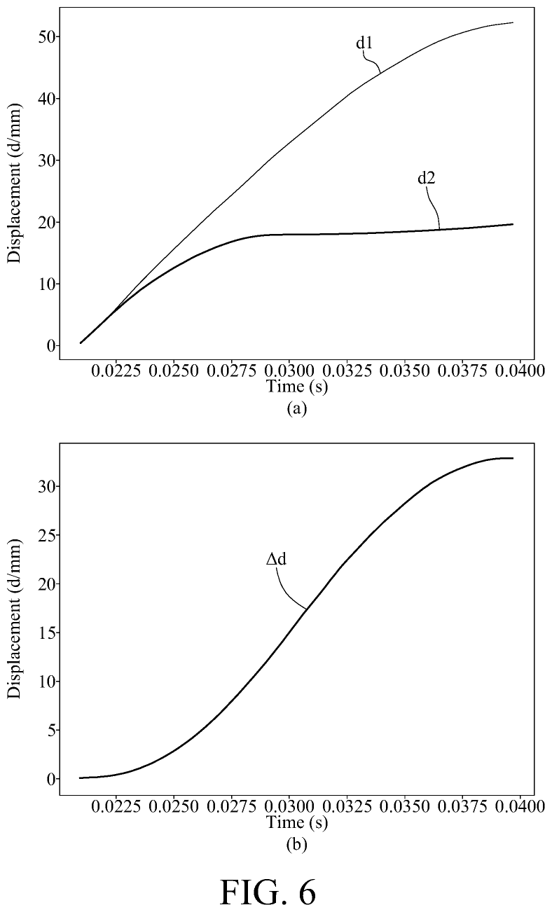

Please refer to FIG. 6 as well, FIG. 6 illustrates exemplary diagrams of obtaining the strain curve according to the first displacement curve and the second displacement curve. Please first refer to part (a) of FIG. 6, the first displacement curve d1 and the second displacement curve d2 are obviously two different curves, therefore, the object strain curve Δd as part (b) of FIG. 6 shown may be obtained by subtracting the first displacement curve d1 and the second displacement curve d2. In this embodiment, the second displacement curve d2 is subtracted from the first displacement curve d1 to obtain the object strain curve Δd, but the present disclosure is not limited thereto. Further, part (a) of FIG. 6 shows the first displacement curve d1 and the second displacement curve d2 in the same diagram is merely for explanation, in actual operation, the two displacement curves being drawn in the same diagram may be omitted.

Please then refer to FIG. 7, FIG. 7 illustrates diagrams of the tested stress-strain curve and the simulated stress-strain curve. After obtain the object strain curve Δd in step S30 and the object stress curve in step S40, the object strain curve Δd and the object stress curve may be combined to obtain the tested stress-strain curve EXP as shown in FIG. 7. The implementation of step S50 may be inputting the previous data point Prev_P into the exponential equation to calculate the next data point Cal_P, and the simulated segment formed by the previous data point Prev_P and the next data point Cal_P may be used as a part of the simulated stress-strain curve SIM. When calculating the first next data point Cal_P, the previous data point Prev_P is preferably the last stress-strain data on the tested stress-strain curve EXP. After the next data point Cal_P is calculated, the next data point Cal_P may be used to update the previous data point Prev_P, the next data point Cal_P may be used as the new “previous data point” to calculate the next “next data point” following the next data point Cal_P. The simulated stress-strain curve SIM is formed by connecting a plurality of simulated segments that are generated by this method in series. Further, when calculating the next data point, a fixed strain interval Δε is preferably used as the base for calculating the next data point (that is, the interval between the strain value of the previous data point and the next data point is Δε). In this example, the strain interval Δε is 0.1, but the present disclosure does not limit the actual value of the strain interval Δε.

To be more specific, the exponential equation may comprise the following equations (1) and (2):

$${σ}_{n + 1} = {σ}_{n} + \frac{\partial σ}{\partial ε} {\vert}_{ε1} {( \frac{1 - {ε}_{1}}{1 - {ε}_{n}} )}^{m} ε \qquad ( 1 )$$

$$m = ln ( ( {σ}_{2} - {σ}_{1} ) / \frac{\partial σ}{\partial ε} {\vert}_{ε1} ε ) / ln ( \frac{1 - {ε}_{1}}{1 - {ε}_{2}} ) \qquad ( 2 )$$

In equation (1), σₙ₊₁ is a next simulated stress data point (for example, the stress value of the next data point Cal_P); σₙ is a previous simulated stress data point (for example, the stress value of the previous data point Prev_P). As described above, when calculating the first “next data point”, the previous data point is preferably the last stress data on the tested stress-strain curve EXP.

In equation (2), σ₂ is a terminal stress data point of each one of the simulated curve segments (for example, the stress value of the next data point Cal_P); σ₁ is a stress data point previous to the terminal stress data point (for example, the stress value of the previous data point Prev_P); εₙ is a next simulated strain data point (for example, the strain value of the next data point Cal_P); ε₂ is a terminal strain data point of each one of the simulated curve segments (for example, the strain value of the next data point Cal_P); ε₁ is a strain data point previous to the terminal strain data point (the previous strain data point of ε₂);

$$\frac{\partial σ}{\partial ε} {\vert}_{ε1}$$

is a partial differential value of the exponential equation at ε₁, wherein εₙ>ε₁, ε₂>ε₁ and the interval between ε₂ and ε₁ may be the strain interval Δε as described above.

It should be noted that, even σₙ₊₁ and σ₂ may both be the stress value of the next data point Cal_P, since σₙ₊₁ is the stress value calculated based on equation (1), and σ₂ is used in equation (2) to calculate σₙ₊₁ in equation (1), therefore, σₙ₊₁ and σ₂ may be the same or different; similarly, σₙ and σ₁ may be the same with each other or different from each other, the present disclosure does not limit the actual value of the above parameters.

As described above, after the tested stress-strain curve EXP is obtained and the simulated stress-strain curve SIM is calculated in step S50 based on the tested stress-strain curve EXP, the simulated stress-strain curve SIM calculated in step S50 may be used to follow the tested stress-strain curve EXP to obtain the complete stress-strain curve as shown in FIG. 7, and the strain value of the final data point on the complete stress-strain curve may be close to 1.

In view of the above description, the stress-strain curve simulation method according to one or more embodiment of the present disclosure, a more accurate simulated stress-strain curve may be calculated based on the acceleration data of the mass block and the testing platform obtained during the drop test. Therefore, in the subsequent computer aided engineering (CAE) simulation, the simulation result may be more accurate. Furthermore, in the conventional stress-strain test, the closer the strain value to 1 is, the more difficult to obtain said strain value. According to one or more embodiment of the stress-strain curve simulation method of the present disclosure, in the strain range of [0, 1), the strain value that is close to 1 may be obtained. Therefore, when performing simulation by using CAE software, a wider range of stress and strain value may be used as the bases for simulation.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. A stress-strain curve simulation method, for calculating a simulated stress-strain curve of a test object sandwiched between a mass block and a testing platform, the method comprising:
obtaining a first acceleration curve and a second acceleration curve, wherein the first acceleration curve is associated with a plurality of pieces of acceleration data of the mass block, and the second acceleration curve is associated with a plurality of pieces of acceleration data of the testing platform;
extracting a part of the first acceleration curve within a time period to obtain a first valid curve, and extracting a part of the second acceleration curve within the time period to obtain a second valid curve;
obtaining an object strain curve according to the first valid curve and the second valid curve;
calculating an object stress curve based on the first valid curve and a contact area between the mass block and the test object; and
calculating the simulated stress-strain curve using an exponential equation based on the object strain curve and the object stress curve, wherein the simulated stress-strain curve is used to follow a tested stress-strain curve.

2. The method according to claim 1, wherein
a starting point of the first valid curve is a point where the first acceleration curve is greater than zero, and an end point of the first valid curve has a peak value of the first acceleration curve.

3. The method according to claim 1, wherein obtaining the object strain curve according to the first valid curve and the second valid curve comprises:
performing an integration procedure on each of the first valid curve and the second valid curve to obtain a first displacement curve and a second displacement curve; and
performing subtraction on the first displacement curve and the second displacement curve to obtain the object strain curve.

4. The method according to claim 3, wherein performing the integration procedure on the first valid curve comprises:
integrating the first valid curve to obtain a first integrated velocity curve;
performing subtraction on a first initial velocity of the mass block and each of a plurality of data points on the first integrated velocity curve to obtain a first relative velocity curve; and
integrating the first relative velocity curve to obtain the first displacement curve.

5. The method according to claim 3, wherein performing the integration procedure on the second valid curve comprises:
integrating the second valid curve to obtain a second integrated velocity curve;
performing subtraction on a second initial velocity of the testing platform and each of a plurality of data points on the second integrated velocity curve to obtain a second relative velocity curve; and
integrating the second relative velocity curve to obtain the second displacement curve.

6. The method according to claim 1, wherein calculating the simulated stress-strain curve comprises:
using a final data point on the tested stress-strain curve as a previous data point;
inputting the previous data point into the exponential equation to calculate a next data point; and
updating the previous data point by the next data point.

7. The method according to claim 6, wherein the exponential equation is a third-order exponential equation or a seventh-order exponential equation, and a strain interval exists between a strain value of the previous data point and a strain value of the next data point.

8. The method according to claim 1, wherein the simulated stress-strain curve is generated by a plurality of simulated curve segments connected in series, the exponential equation comprises:
$${σ}_{n + 1} = {σ}_{n} + \frac{\partial σ}{\partial ε} {\vert}_{ε 1} {( \frac{1 - {ε}_{1}}{1 - {ε}_{n}} )}^{m} ε$$
$$m = ln ( ( {σ}_{2} - {σ}_{1} ) / \frac{\partial σ}{\partial ε} {\vert}_{ε 1} ε ) / ln ( \frac{1 - {ε}_{1}}{1 - {ε}_{2}} )$$
wherein σₙ₊₁ is a next simulated stress data point; σₙ is a previous simulated stress data point; σ₂ is a terminal stress data point of each one of the simulated curve segments; σ₁ is a stress data point previous to the terminal stress data point; εₙ is a next simulated strain data point; ε₂ is a terminal strain data point of each one of the simulated curve segments; ε₁ is a strain data point previous to the terminal strain data point;
$$\frac{\partial σ}{\partial ε} {\vert}_{ε1}$$
is a partial differential value of the exponential equation at ε₁,
wherein a strain interval exists between the terminal strain data point and its previous strain data point, and εₙ>ε₁, ε₂>ε₁.

9. The method according to claim 1, further comprising:
combining the object strain curve and the object stress curve to obtain the tested stress-strain curve; and
continuing the tested stress-strain curve with the simulated stress-strain curve to obtain a complete stress-strain curve.

10. The method according to claim 1, wherein calculating the object stress curve based on the first valid curve and the contact area between the mass block and the test object comprises:
calculating a counter force curve based on the first valid curve and the mass of the mass block; and
calculating the object stress curve based on the counter force curve and the contact area.
